(19) United States
(12) Patent Application Publication
(10) Pub. No.: US 2026/0158556 A1
(43) Pub. Date: Jun. 11, 2026

(54) Method for manufacturing a steel object by powder bed fusion

(71) Applicant: Commissariat à l’Energie Atomique et aux Energies Alternatives, Paris (FR)

(72) Inventors: Pierre-François GIROUX, Louviers (FR); Hicham MASKROT EL IDRISSI, Antony (FR); William BURGE-CATINOT, Igny (FR)

(73) Assignee: Commissariat à l’Energie Atomique et aux Energies Alternatives, Paris (FR)

(21) Appl. No.: 19/413,854

(22) Filed: Dec. 9, 2025

(30) Foreign Application Priority Data
Dec. 10, 2024 (FR) 2413810

(51) Int. Cl. B22F 10/28; B33Y 10/00

(52) U.S. Cl. CPC B22F 10/28; B33Y 10/00; B22F 2201/02; B22F 2201/11; B22F 2301/35; B22F 2998/10

(57) ABSTRACT

The invention relates to a process for manufacturing a steel object by powder bed fusion, characterized in that it comprises the following steps:
a) providing a layer of steel powder 316L comprising not more than 200 ppm nitrogen, the powder used not having undergone any special atomization or chemical pretreatment,
b) consolidating the powder layer by powder bed fusion in a controlled atmosphere at an Argon (Ar) partial pressure p_{Ar} such that 0≤p_{Ar}<1 and a dinitrogen (N₂) partial pressure such that 0<p_{N2}≤1, with p_{Ar}+p_{N2}=1,
c) repeating steps a) and b) as necessary to manufacture the steel object.

### TECHNICAL FIELD OF THE INVENTION

The invention relates to the field of manufacturing a steel object by powder bed fusion.

The invention can be used in a wide range of industrial sectors, including the power generation, aeronautics, space and the automotive industry.

### TECHNICAL BACKGROUND

The methods involved in manufacturing a steel object using powder bed fusion have been the subject of in-depth research for several years.

The parameters accessible and modifiable within the equipment available on the market to implement such methods (e.g. for laser powder bed fusion: laser power, laser scanning speed, etc.) and the optimization of the geometry of the equipment used to implement these methods have a major impact on the performance of the objects manufactured (mechanical properties, etc.). Mastering these various parameters is an integral part of the technical expertise of the equipment manufacturers.

In addition, studies have shown that the physico-chemical characteristics of the steel powders used also have a significant influence on the characteristics of the objects manufactured in this way. For example, it has been shown that modifying the content of minor elements, particularly nitrogen and oxygen, in a steel powder 316L leads to significant changes in the microstructural characteristics of the object obtained after manufacture (grain size, texture and precipitation within the metal matrix in particular), which can also have an impact on the performance of the object finally obtained (mechanical characteristics, etc).

In the current state of knowledge, controlling the performance of the final object, linked to these microstructural characteristics, involves specific pre-treatment processes for the powders used and loaded into the equipment used to implement the powder bed fusion method.

To control the characteristics of the final product, the existing options based on the physico-chemistry of powders consist of:
modifying the powder atomization method (usually carried out by powder manufacturers and suppliers), which is complex and potentially costly and/or;
insert one or more pre-treatment stages for the powders, eliminating traces of undesirable chemical species, which makes manufacture longer and more expensive.

It should be noted that, in the state of the art, the nitrogen content is generally set before consolidation takes place, for example during powder atomization or powder pre-treatment. The skilled person therefore uses a steel powder with a fixed content and then consolidates it. The result is a steel with microstructural characteristics that depend on the nitrogen content of the steel powder supplied, with consolidation having no effect on this nitrogen content.

Furthermore, in some cases, it may be necessary to manufacture a part whose microstructural properties are not the same everywhere. In this case, the usual approach is to change the powder during manufacture, which leads to a loss of productivity and increased complexity (protocol for interrupting and restarting manufacture, etc.). The various powders used may have been atomized or pre-treated in different ways.

One aim of the invention is to provide an improved process for manufacturing a steel object by powder bed fusion.

In particular, one objective of the invention is to propose a method for manufacturing a steel object by powder bed fusion, enabling the microstructural properties of the object to be manufactured to be modified during manufacture, without interrupting the manufacturing method.

### SUMMARY OF THE INVENTION

To solve the above-mentioned objective, the invention proposes a method for manufacturing a steel object by powder bed fusion, characterized in that it comprises the following steps:
a) providing a steel powder layer 316L comprising not more than 200 ppm of nitrogen, the powder used not having undergone any special atomization or chemical pretreatment,
b) consolidating the powder layer by powder bed fusion in a controlled atmosphere at an Argon (Ar) partial pressure p_{Ar} such that 0≤p_{Ar}<1 and a dinitrogen (N₂) partial pressure such that 0<p_{N2}≤1, with p_{Ar}+p_{N2}=1,
c) repeating steps a) and b) as necessary to manufacture the steel object.

The method according to the invention may comprise at least one of the following additional characteristics, taken alone or in combination:
the steel powder supplied in step a) comprises at most 170 ppm of nitrogen, advantageously at most 150 ppm of nitrogen;
in step b), the partial pressure (p_{N2}) of dinitrogen is varied;
step b) is carried out using a powder bed fusion selected from: laser powder bed fusion or concentrated energy deposition;
step b) is carried out using a laser powder bed fusion, with the following parameters:
   laser power: 50 to 200 W,
   slew rate: 0.3 to 3 m/s,
   thickness of a powder layer: 10 to 100 microns,
   distance between strands: 10 to 150 microns.
in step c), the partial pressure of dinitrogen is varied.

### BRIEF DESCRIPTION OF THE FIGURES

Further objects and characteristics of the invention will become clearer in the following description, made with reference to the attached figures, wherein:

FIG. 1 is a schematic representation of the main stages of the method according to the invention;

FIG. 2 shows an apparatus for carrying out the method in accordance with the invention using the laser powder bed fusion technique;

FIG. 3(a) is a crystalline orientation map produced by electron backscatter diffraction of a steel 316L obtained using a method in accordance with the prior art;

FIG. 3(b) shows a crystal orientation map produced by electron backscatter diffraction of a steel 316L obtained using a method in accordance with the invention;

FIG. 4 shows different crystalline orientation maps produced by electron backscatter diffraction of a steel 316L obtained using a method in accordance with the prior art, and for different nitrogen contents in the powder according to images (a) to (e).

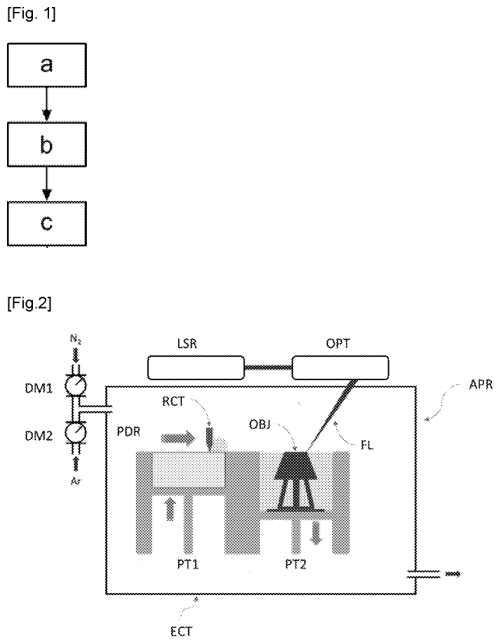

### DETAILED DESCRIPTION OF THE INVENTION

The invention relates to a method for manufacturing a steel object by powder bed fusion. The method comprises the following steps:
a) providing a steel powder layer 316L comprising not more than 200 ppm nitrogen, the powder used not having undergone any special atomization or chemical pretreatment,
b) consolidating the powder layer by powder bed fusion in a controlled atmosphere at an Argon (Ar) partial pressure Par such that 0<p_{Ar}<1 and a dinitrogen (N₂) partial pressure such that 0<p_{N2}≤1, with p_{Ar}+p_{N2}=1,
c) repeating steps a) and b) as necessary to manufacture the steel object.

Typically, the powder bed fusion is carried out in a controlled atmosphere of Argon (p_{Ar}=1).

However, the invention shows that modifying the atmosphere in which a steel powder with a low nitrogen content (<200 ppm) is consolidated has an impact on the granular structure of the steel formed and therefore, in particular, on the mechanical properties of the steel product thus produced. This is done without the need for any special atomization or chemical pretreatment of the powder used. In the context of the invention, the nitrogen content in the steel powder can be varied during consolidation by powder bed fusion.

The invention is therefore all the more non-trivial with regard to the existing prior art in that the consolidation kinetics in powder bed fusion (in particular in laser powder bed fusion), which are particularly high, make it uncertain for the person skilled in the art to be able to manage or predict the interaction of the dinitrogen in the enclosure with the melt and its diffusion in the consolidated material at the origin of the modification of the microstructure. The difference in kinetics between these two phenomena (consolidation on the one hand, diffusion on the other) is very significant.

Advantageously, the steel powder supplied in step a) will comprise at most 170 ppm of nitrogen, even more advantageously at most 150 ppm.

Furthermore, within the scope of the invention, it is possible to vary the partial pressure (p_{N2}) of dinitrogen during the step b).

This allows gradually to control and modify the granular structure (grain size, texture) of the consolidated steel along the powder layer during consolidation. We can then obtain a steel object with a gradient in the granular structure and therefore in the mechanical properties depending on the direction of consolidation. In particular, if the consolidation is carried out using a powder scanning technique, which is by way of a non-limiting example the case with laser powder bed fusion, it is possible to create two gradients, defined by the two orthogonal X, Y directions of the plane of the powder bed.

Similarly, it is possible to vary the partial pressure (p_{N2}) of dinitrogen during step c). By this we mean that when step b) is repeated, i.e. when another powder layer is consolidated on top of the previous one.

This allows gradually to control and modify the granular structure (grain size, texture) of the consolidated steel, layer by powder layer during consolidation. We can then obtain a steel object with a gradient in the granular structure and therefore in the mechanical properties depending on the direction in which the layers are stacked. This gradient is then defined along a direction Z perpendicular to the directions X, Y.

The powder bed fusion is chosen from: the laser powder bed fusion (L-PBF) or directed energy deposition (DED).

Furthermore, when the method according to the invention is implemented with laser powder bed fusion, the following parameters can be provided:
laser power: 50 to 200 W,
slew rate: 0.3 to 3 M/s,
thickness of a powder layer: 10 to 100 microns,
distance between strands: 10 to 150 microns.

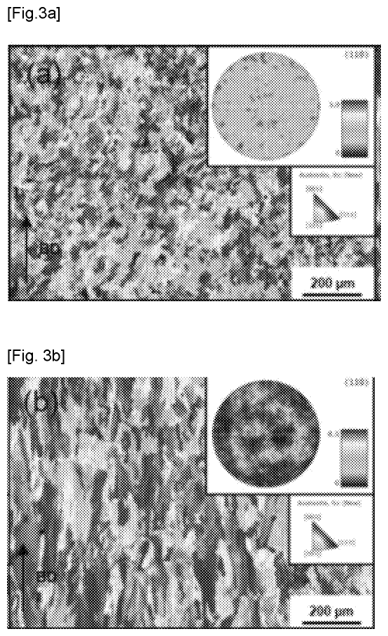

FIG. 2 shows an apparatus capable of carrying out the method according to the invention, in the particular case of a laser powder bed fusion. This same apparatus is also capable of implementing a method in accordance with the prior art.

This apparatus APR comprises an enclosure ECT in which a controlled atmosphere is configured to prevail. Within the enclosure, there is a container comprising the powder PDR, which can be moved by a piston PST1, the movement of which allows a predefined quantity of powder to be extracted. This powder PDR can be conveyed by a scraper RCT to another container used to consolidate the powder using a laser beam FL. This other container is mounted on a piston PST2 to descend as layers of powder are conveyed in for the manufacture of the steel object OBJ. The laser beam FL is generated by a laser LSR, the output beam of which is conditioned by an optical assembly OPT before being directed towards the powder layer to be consolidated. The atmosphere in the enclosure ECT can be controlled with an appropriate quantity of dinitrogen and argon, managed by dedicated flowmeters DM1 and DM2 respectively.

The above-mentioned advantages of the method according to the invention will be better understood in the light of the tests (test 2 versus test 1 and additional tests) presented below.

### Test 1 (Prior Art Reference)

The steel powder 316L is made up of particles with a particle size in the range 15 to 45 μm (spherical grains), with a nitrogen content of 200 ppm or less (low nitrogen content). This powder is fed into the powder reservoir RP in the manufacturing equipment, in this case a TruPrint® 1000 ytterbium-doped fiber laser machine (wavelength 1064 nm, laser spot 55 μm).

The low-nitrogen steel powder 316L is then consolidated in the manufacturing enclosure under a controlled atmosphere of Argon (Ar). The argon is industrial grade, with a purity greater than 99.99% by volume. The parameters used for consolidation are as follows:
laser power: 165 W
slew rate: 450 mm/s
layer thickness: 30 μm
distance between strands: 60 μm.

### Test 2 (in Accordance With the Invention)

In test 2, the consolidation is carried out under a controlled atmosphere of dinitrogen (N₂). The dinitrogen (N₂) is industrial grade, with a purity greater than 99.99% by volume. Everything else is identical to the test 1, in particular the type of powder used, the equipment used and the consolidation parameters applied.

FIG. 3(a) and FIG. 3(b) show, respectively, the microstructural properties of the steel product 316L thus produced for the prior art reference (test 1) and the invention (test 2).

These figures show the crystalline orientation maps produced by electron back scattered diffraction (EBSD) of the steel 316L.

Compared to the material consolidated under an argon atmosphere (FIG. 3(a)/prior art), the consolidation of a steel 316L produced by laser powder bed fusion from a powder with a nitrogen content of less than 200 ppm in an enclosure filled with dinitrogen (FIG. 3 (b)/invention) results in a significant change in the granular structure of the final product.

In this case, if we compare the structure in FIG. 3(b) with that in FIG. 3(a), we can see that:
the morphology of the grains shows a columnar structure oriented in the direction of construction (BD) in FIG. 3(b), whereas this structure is quasi-equiaxial in FIG. 3(a);
the grain size is multiplied by a factor of between 2.5 and 4 between FIG. 3(b) and FIG. 3(a),
the texture is more pronounced in the <110> direction in FIG. 3(b).

The comparison of the two tests (test 1 / test 2) therefore provides proof that the change in atmosphere in which the steel powder is consolidated has an impact on the granular structure of the steel formed and therefore, in particular, on the mechanical properties of the steel product thus manufactured. Furthermore, in the context of the invention, the powder used has not undergone any particular atomization or chemical pre-treatment.

### Additional Tests

Other tests were carried out using the prior art method, more precisely under the conditions mentioned above for the test 1, but with steel powders 316L with different nitrogen contents, namely (a) 93±7 ppm, (b) 169±22 ppm, (c) 292±23 ppm, (d) 452±53 ppm and (e) 558±22 ppm.

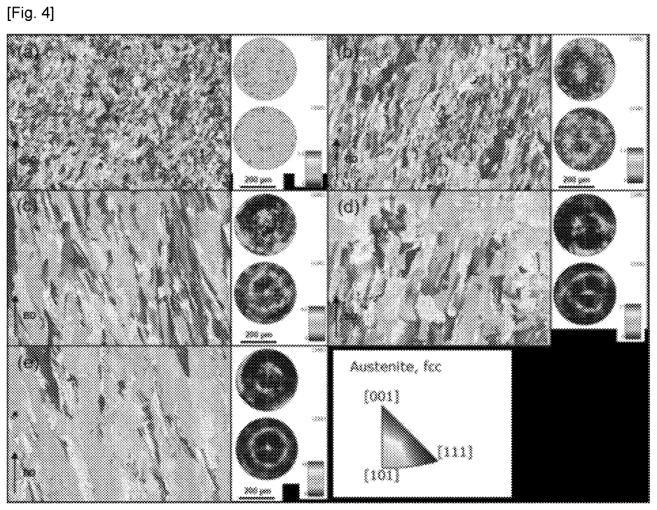

The crystal orientation maps obtained by Electron Back Scattered Diffraction (EBSD) of the steel 316L for cases (a) to (e) are shown in FIG. 4.

It can be seen that the gradual addition of nitrogen to the steel powder 316L enables a transition from a quasi-equiaxed structure (case (a) with a low nitrogen content: <200 ppm; a structure similar to that in FIG. 3(a)) to a columnar structure (case (c) with a nitrogen content >200 ppm, passing through an intermediate state which is that of case (b)). The cases (d) and (e) (nitrogen content >200 ppm in the powder) are characterized by a granular structure that is also columnar, but coarser than that observed in the case (c).

In passing, it should be noted that the columnar structure of the steel 316L obtained in FIG. 3(b) (invention) is similar to that of FIG. 4, case (c) and, more generally, can also be considered similar to those of FIG. 4, cases (d) and (e).

From all these tests, it is therefore also understood that it is of little importance to start from a steel powder with a predetermined quantity of nitrogen, for example because in accordance with a method of the prior art, a conventional steel powder with a low nitrogen content has been pre-treated to add nitrogen and then consolidated in an Argon atmosphere, or alternatively, in accordance with the invention, to start from a conventional powder containing a low quantity of nitrogen (<200 ppm) and then consolidated under a nitrogen atmosphere to define a granular structure and equivalent mechanical properties, in both cases, of the manufactured steel product.

Thus, to the extent that the results shown in FIG. 4 for different nitrogen contents of the powder can be transposed to the invention, starting with a conventional powder with a low nitrogen content (<200 ppm), then by adjusting a partial pressure of dinitrogen (p_{N2}) relative to a partial pressure of Argon (p_{AR}) with p_{Ar}+p_{N2}=1, it is possible to obtain all types of intermediate structures between that of FIG. 3(a) (prior art/outside the invention) and that of FIG. 3(b) (partial pressure of dinitrogen p_{N2}=1).

In particular, it is understood that it is conceivable, starting from an atmosphere under Argon (Ar) and by progressively adding dinitrogen (N₂) within the enclosure of the apparatus for carrying out laser powder bed fusion, to make a transition from one granular structure to another during manufacture, in particular deposition layer after deposition layer. This involves varying the partial pressure of dinitrogen during the manufacture of the object. As a result, it is possible to manufacture a steel object whose granular structure evolves according to a gradient directed in the direction of deposition of the powder layers successively deposited for consolidation.

1. A method of manufacturing a steel article by powder bed fusion, wherein it comprises the following steps:
a) providing a steel powder layer 316L comprising at most 200 ppm of nitrogen, the powder used not having undergone any special atomization or chemical pretreatment,
b) consolidating the powder layer by powder bed fusion in a controlled atmosphere at an Argon (Ar) partial pressure p_{Ar} such that 0≤p_{Ar}<1 and a dinitrogen (N₂) partial pressure such that 0<p_{N2}≤1, with p_{Ar}+p_{N2}=1,
c) repeating steps a) and b) as necessary to manufacture the steel object.

2. The method according to claim 1, wherein the steel powder supplied in step a) comprises at most 170 ppm of nitrogen, advantageously at most 150 ppm nitrogen.

3. The method according to claim 1, wherein, during step b), the partial pressure (p_{N2}) of dinitrogen is varied.

4. The method according to claim 1, wherein step b) is carried out with powder bed fusion selected from: the laser powder bed fusion or the concentrated energy deposition.

5. The method according to claim 1, wherein step b) is carried out with a laser powder bed fusion, with the following parameters:
laser power: 50 to 200 W,
slew rate: 0.3 to 3 m/s,
thickness of a powder layer: 10 to 100 microns,
distance between strands: 10 to 150 microns.

6. The method according to claim 1, wherein, during step c), the partial pressure (p_{N2}) of dinitrogen is varied.
